(19) United States
(12) Patent Application Publication
(10) Pub. No.: US 2014/0211616 A1
(43) Pub. Date: Jul. 31, 2014

(54) Network Assisted Data Flow Mobility

(71) Applicant: Cisco Technology, Inc., San Jose, CA (US)

(72) Inventors: Nirav Kirtikumar Salot, Pune (IN); Rajeev Koodli, Saratoga, CA (US); Maulik Vijay Vaidya, Atlanta, GA (US); Aeneas Dodd-Noble, Andover, MA (US)

(73) Assignee: Cisco Technology, Inc., San Jose, CA (US)

(21) Appl. No.: 14/052,716

(22) Filed: Oct. 12, 2013

Related U.S. Application Data
(60) Provisional application No. 61/759,106, filed on Jan. 31, 2013.

(51) Int. Cl. H04W 28/02

(52) U.S. Cl. CPC H04W 28/0289
USPC 370/230

(57) ABSTRACT

Data flow mobility to a user equipment may be provided. An access routing rule may be received at the user equipment. The access routing rule may include a plurality of packet filters and at least one target access corresponding to each of the plurality of packet filters. A first data packet to be routed may be received at the user equipment. A first packet filter associated with the first data packet may be determined. A first target access corresponding to the first packet filter may be determined from the access routing rule. The first data packet may be routed through the first target access.

### RELATED APPLICATION

Under provisions of 35 U.S.C. §119(e), Applicants claim the benefit of U.S. Provisional Application No. 61/759,106, filed on Jan. 31, 2013, which is incorporated herein by reference in its entirety.

### TECHNICAL FIELD

The present disclosure relates generally to communication network.

### BACKGROUND

As the use of mobile wireless devices, such as smart phones and tablet devices, becomes more ubiquitous, the demands on the limited amount of radio frequency spectrum used by those devices has increased. The increase in demand has resulted in wireless network congestion and reduced bandwidth for devices operating in the licensed spectrum. A variety of techniques have been introduced to provide additional bandwidth. One of the techniques includes data offloading from a Wireless Wide Area Network (WWAN) operated in licensed spectrum to other networks such as another WWAN or a Wireless Local Area Network (WLAN) operated in unlicensed spectrum. For example, data may be offloaded from a 3G or 4G WWAN operating in accordance with a standard from the 3GPP standards family, to a Wi-Fi WLAN operating in accordance with a standard from the 802.11 standards family.

### BRIEF DESCRIPTION OF THE FIGURES

The accompanying drawings, which are incorporated in and constitute a part of this disclosure, illustrate various embodiments of the present disclosure. In the drawings:

FIG. 1 shows a system where embodiments of the disclosure may be practiced;

FIG. 2 shows a flow diagram for providing data flow mobility;

FIG. 3 shows a traffic flow template information element;

FIG. 4 shows a packet filter list;

FIG. 5 shows enhanced traffic flow template information element

FIG. 6 shows an access routing rule;

FIG. 7 shows another access routing rule;

FIG. 8 shows yet another access routing rule; and

FIG. 9 shows a user equipment.

### DETAILED DESCRIPTION

### Overview

Data flow mobility to a user equipment may be provided. An access routing rule may be received at the user equipment. The access routing rule may comprise a plurality of packet filters and at least one target access corresponding to each of the plurality of packet filters. A first data packet may be received at the user equipment. A first packet filter associated with the first data packet may be determined. A first target access corresponding to the first packet filter may be determined from the access routing rule. The data packet may be routed through the determined first target access.

Both the foregoing overview and the following example embodiment are examples and explanatory only, and should not be considered to restrict the disclosure's scope, as described and claimed. Further, features and/or variations may be provided in addition to those set forth herein. For example, embodiments of the disclosure may be directed to various feature combinations and sub-combinations described in the example embodiment.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Wireless devices, such as mobile phones, may use a radio link to send and receive data. The wireless devices may send and receive the data over the radio link while moving around in a wide geographical area. For example, the wireless devices may send and receive the data by connecting to a cellular network provided by a mobile phone operator, allowing access to a public telephone network. One such public telephone network may include the 3rd Generation Partnership Project (3GPP) access network.

The increase in number of wireless devices and the volume of data being exchanged using these wireless devices, can result in wireless network congestion and reduced bandwidth for devices operating in the licensed spectrum. Embodiments of the present disclosure provide solutions to alleviate the network congestion. For example, embodiments may include offloading the data from the 3GPP access network to other networks such as another wireless wide area network (WWAN) or a wireless local area network (WLAN). A WLAN may be a linking of two or more computers or devices over an air interface. The WLAN may utilize radio waves to enable communication between devices in a limited area through technologies such as Wi-Fi.

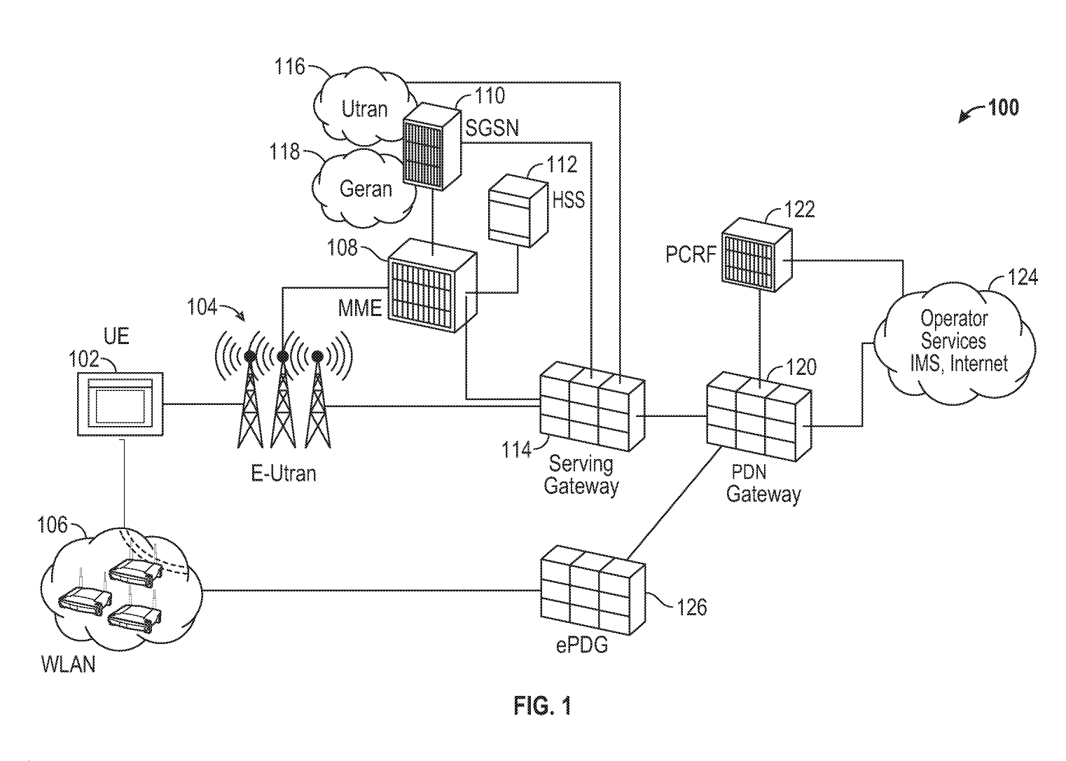

FIG. 1 illustrates a system 100 in which embodiments of the disclosure may be practiced. As illustrated in FIG. 1, system 100 may include a user equipment (UE) 102. UE 102 may be a wireless device such as a mobile phone. UE 102 may connect to a 3GPP access network via an evolved universal mobile telecommunication system (UMTS) terrestrial radio access network (E-UTRAN) 104. E-UTRAN 104 may be a 3GPP radio access network for long term evolution (LTE) 3.9G. The 3GPP access network may also be referred to as a core network. UE 102 may further connect to a wireless local area network (WLAN) 106. Hence, UE 102 may connect to multiple networks, such as E-UTRAN 104 and WLAN 106, via radio interfaces. UE 102 may be configured to connect to E-UTRAN 104 through a long term evolution (LTE-Uu) interface. UE 102 may connect to WLAN 106 through a wireless interface such as Wi-Fi. WLAN 106 may be a trusted WLAN 106 or an untrusted WLAN 106.

As illustrated in FIG. 1, system 100 may include a mobile management entity (MME) 108. MME 108 may be connected to E-UTRAN 104, and may be configured to control an UE 102 access to E-UTRAN 104. For example, MME 108 may be responsible for idle mode UE 102 tracking and paging procedure including retransmissions. MME 108 may further be involved in a bearer activation/deactivation process. For example, MME 108 may be responsible for choosing a serving gateway 114 for UE 102 at an initial attach. Serving gateway 114 may be connected to E-UTRAN 104 and to MME 106.

Serving gateway 114 may be configured to route and forward data packets. In addition, serving gateway 114 may serve as a mobility anchor for a user plane during handovers and as the anchor for mobility between long term evolution (LTE) and other 3GPP technologies. For example, serving gateway 114 may relay traffic between 2G/3G systems and packet data network (PDN) gateway 120.

PDN gateway 120 may provide connectivity from UE 102 to external packet data networks, such as WLAN 106. Such connectivity may be achieved by making PDN gateway 120 as the point of exit and entry of data traffic for UE 102. In addition, PDN gateway 120 may perform policy enforcement, packet filtering for each user, charging support, lawful interception, and packet screening. For example, PDN gateway 120 may act as an anchor for data mobility between the 3GPP access network and WLAN 106.

PDN gateway 120 may be connected to a policy and charging rules function (PCRF) 122 node. PCRF 122 may be a software node designated in real time to determine policy and charging rules. For example, PCRF 122 may provide a platform to create multiple charging rates in real time for users active on the core network. PCRF 122 may aggregate information to and from the core network, and other sources (such as various operator services 124) in real time. Operator services 124 may include, for example, an IP multimedia subsystem (IMS) and the Internet.

PDN gateway 120 may further be connected to an evolved packet data gateway (ePDG) 126. ePDG 126 may be configured to secure the data transmission with UE 102 connected to an untrusted WLAN 106. PDN gateway 120 may connect to a trusted WLAN 106.

MME 108 may further be connected to a home subscriber server (HSS) 112. HSS 112 may be a database containing user-related and subscription-related information. Functions of HSS 112 may include mobility management, call and session establishment support, user authentication and access authorization.

MME 108 may further be connected to a global packet radio service (GPRS) support node (SGSN) 110. SGSN 110 may deliver data packets from and to mobile stations within its geographical service area. For example, SGSN 110 may perform data packet routing and data packet transfer, mobility management (attach/detach and location management), logical link management, and authentication and charging functions. A location register of SGSN 110 may store location information (e.g., current cell) and user profiles (e.g. addresses) used in the packet data network) for all GPRS users registered with it. SGSN 110 may be used to facilitate universal mobile telecommunication system (UMTS) terrestrial radio access network (UTRAN) 116 (also referred to as 3G) and global system for mobile (GSM) enhanced data rates for GSM evolution (EDGE) radio access network (GERAN) 118 (also referred to as 2G or 2.5G).

UE 102 may gain simultaneous access to multiple networks (such as E-UTRAN 104 and WLAN 106). With access to these multiple networks, UE 102 may be configured to send and receive data packets simultaneously over these multiple networks. For example, a data packet received at UE 102 may be routed upstream via any of E-UTRAN 104 and WLAN 106. In addition, the data packets related to one internet protocol (IP) flow may be routed via one of the radio access technology, e.g. E-UTRAN 104. While this IP flow is active, the data packets may be routed via another radio access technology, e.g. WLAN 106. Such ability of UE 102 to move the IP flow and route the corresponding data packets over the multiple networks may be referred to as data flow mobility.

Data flow mobility, (such as IP Flow mobility (IFOM)), may be provided with assistance from the core network. The data flow mobility provided with assistance from the core network may be referred to as network assisted IFOM. In the network assisted IFOM, the core network, such as PDN gateway 120, may maintain control over flow parameters of the data flow mobility. The flow parameters may include eligibility criteria for data packet binding with different networks. The flow parameters may be defined by the core network and may be dynamic in nature. For example, the flow parameters for an IP flow may only be available or defined when the IP flow is active.

The dynamic nature of the flow parameters may make it infeasible to pre-configure these flow parameters at UE 102. For example, the flow parameters may not be configured before UE 102 has gained access to the multiple networks. Once the core network decides binding between the access type and a particular IP flow, the core network may need to provide the corresponding flow parameters (also referred to as binding information) to UE 102. UE 102 may use the flow parameters received from the core network to perform access binding for the IP flow. For example, the network may deliver a list of IP flows and corresponding access binding information to UE 102 (e.g. IP flow1=>3GPP access (e.g. E-UTRAN 104); IP flow2=>WLAN 106 access, etc.). The binding information may also be referred to as access routing rules (ARR). ARR may be delivered to UE 102, and UE 102 may gain control of moving the IP flows to the corresponding access. UE 102 may be in the best position to judge the availability of particular access (e.g. the available bandwidth and radio signal quality of WLAN 106 access). Hence, UE 102 may be configured to determine the binding of the IP flow.

ARR may be delivered to UE 102 in multiple different ways. For example, ARR may be delivered to UE 102 via its selected access network. A descriptor of IP flow1 may be delivered to UE 102 via the 3GPP access network and a descriptor of IP flow2 may be delivered via WLAN 106. UE 102 may be configured to assume binding between the IP flow and the access network via which the corresponding IP flow descriptor is received. Thus, a downlink binding of the IP flow at a network element of the core network (such as PDN gateway 120) and uplink binding of the IP flow at UE 102 may be created.

For the 3GPP access network, a mechanism to deliver and modify the IP flow descriptor, using traffic flow template (TFT), is well defined and supported since early releases of the 3GPP. But a mechanism to deliver the IP flow descriptor for WLAN 106 may not exist due to challenges in delivering the IP flow descriptor over WLAN 106. For example, since there is no network access stratus (NAS) like interface for WLAN 106, delivering the IP flow descriptors over WLAN 106 may require enhancements to an existing L2/L3 interface between UE 102 and WLAN 106 access gateway (e.g. WLAN 106 access parameters).

As another example, for trusted WLAN 106 access, an IP flow may require support at UE 102 as well as WLAN 106 access gateway. For untrusted WLAN 106 access, the IP flow may require support at UE 102 and ePDG 126. In order to implement the required support, UE 102, WLAN 106 access gateway, and ePDG 126 may need an upgrade. For example, extensions to neighbor discovery (IPv6), DHCP (IPv4), and IKEv2 protocols may be required. Such extensions may further require support both at the core network and UE 102. Moreover, for the untrusted WLAN 106, an interface between UE 102 and ePDG 126 may be IKEv2 based, and hence enhancements to IKEv2 may be required to deliver the IP flow descriptor. Since IKEv2 may not be used for the trusted WLAN 106, a solution to deliver the IP flow descriptor may be different for trusted and the un-trusted WLAN 106. In other words, different kinds of extensions may be required for the trusted and the untrusted WLAN 106 access.

To overcome the above mentioned challenges, ARR may be delivered to UE 102 from the core network. For example, the ARR may be delivered to UE 102 via the 3GPP access network (e.g. E-UTRAN 104/UTRAN 116/GERAN 118) using the 3GPP NAS interface. Moreover, a single mechanism may be implemented for both the trusted and the untrusted WLAN 106, as well as for IPv4 and IPv6 traffic. Embodiments of the disclosure may provide a mechanism to provide network assisted mobility to UE 102 for binding to both the trusted and the untrusted WLAN 106. More specifically, the embodiments may provide a mechanism to leverage the existing 3GPP NAS interface to deliver ARR to UE 102. Although the mechanism to deliver ARR is discussed with respect to the 3GPP access network and WLAN 106, it may be applicable to other radio networks.

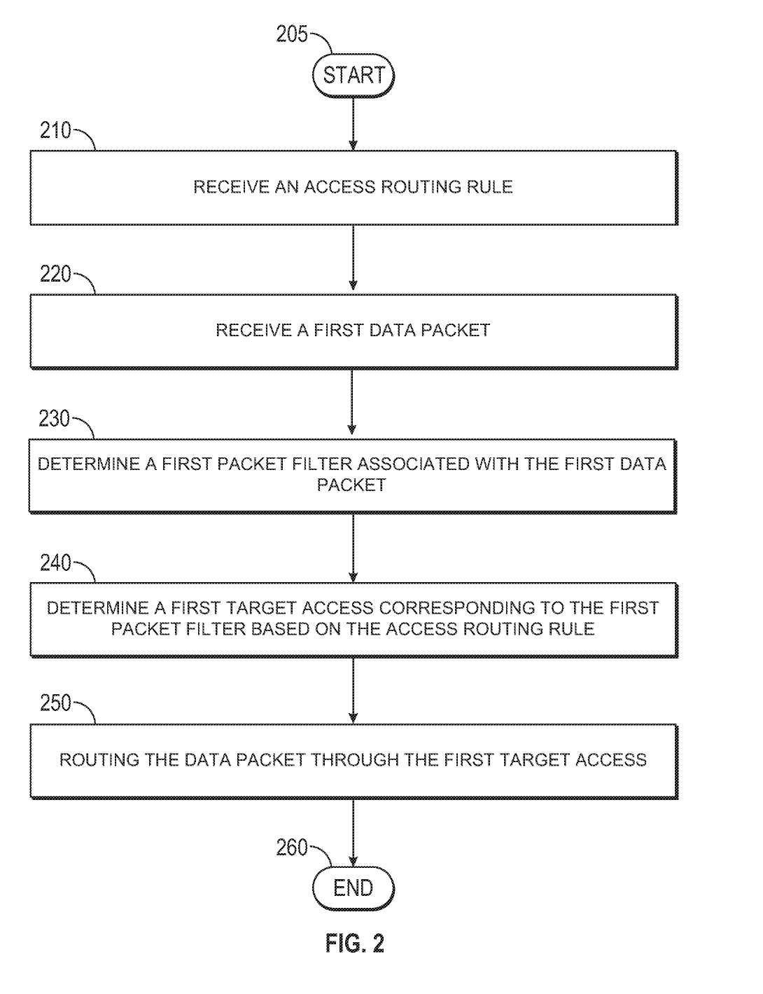

FIG. 2 shows a flow diagram of a method 200 to provide data flow mobility to UE 102. Data flow mobility may refer to ability of UE 102 to move a data flow over more than one communication network. For example, method 200 may provide data flow mobility for UE 102 over WLAN 106 and the 3GPP access network. As shown in FIG. 2, method 200 may begin at block 205, and proceed to stage 210 where an access routing rule (ARR) may be received at user equipment (UE) 102. For example, the ARR may be received over a first communication network which UE 102 has access to, such as a 3GPP access network. The ARR may include a plurality of packet filters and at least one target access corresponding to each of the plurality of packet filters. The target access may correspond to a communication network over which the data packet matching the packet filter may be routed to.

From stage 210, where UE 102 receives the ARR, method 200 may advance to stage 220 where a first data packet may be received at UE 102. For example, UE 102 may receive a first data packet corresponding to a video call to be routed upstream. The first data packet may be received from one of multiple input interfaces such as a microphone, a video camera, a keyboard, etc. associated with UE 102.

After UE 102 has received the first data packet at stage 220, method 200 may advance to stage 230, where UE 102 may determine a first packet filter associated with the first data packet. For example, UE 102 may extract information such a source IP address, a destination IP address, a source port protocol, and a destination port protocol associated with the first data packet. UE 102, based on the extracted information may determine the first packet filter associated with the first data packet. The first packet filter may be defined in a packet structure of the first data packet. For example, the first packet filter may be indicated in a header of the first data packet. In another example, the first packet filter may be indicated in a packet identifier (PID) associated with the first data packet. The first packet filter may include a type of data, such as a video data, an audio data, etc.

After UE 102 has determined the first packet filter associated with the first data packet at stage 230, method 200 may proceed to stage 240 where a first target access corresponding to the first packet filter associated with the first data packet may be determined. For example, UE 102 may perform a lookup operation in the ARR to determine the first target access corresponding to the first packet filter associated with the first data packet.

Once UE 102 has determined the first target access for the first data packet at stage 240, method 200 may proceed to stage 250 where the first data packet may be routed by UE 102 through the first target access. The first target access may be associated with one of a plurality of communication networks available to UE 102. UE 102 may route the first data packet through the communication network associated with the first target access. For example, UE 102 may route the first data packet through the 3GPP access network or WLAN 106. After UE 102 has routed the first data packet through the first target access, method 200 may end at stage 260.

In one embodiment, the ARR may be delivered and modified via the 3GPP access network. The same ARR may be used to route the data packets over WLAN 106. The ARR for the 3GPP access network and for WLAN 106 access may be provided to UE 102 via the 3GPP NAS interface. For example, the ARR may be sent to UE 102 by PDN gateway 120. PDN gateway 120 may use bearer modification procedure to send the ARR to UE 102, as defined in 3GPP TS 23.401 clause 5.4.2.1 or clause 5.4.3 which is incorporated herein in its entirety.

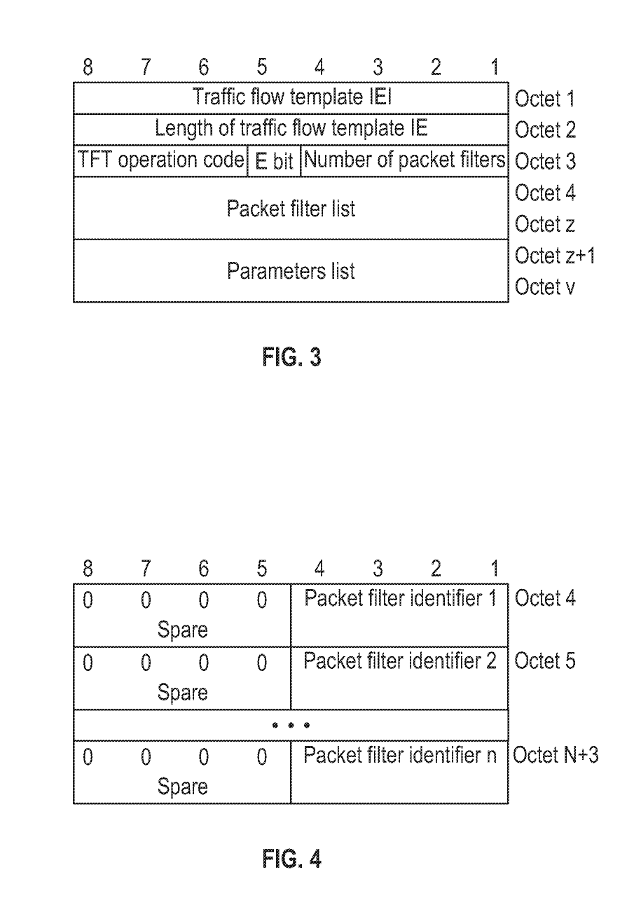

The ARR may be delivered to UE 102 in a standard flow IP flow template. For example, the ARR may be delivered to UE 102 in a traffic flow template (TFT). An example of a TFT 300 with information element is shown with respect to FIG. 3. As shown in FIG. 3, the information element in TFT 300 may include a packet filter list and a parameters list. The information element may be modified to add a target access field to a packet filter field. An example template with added packet filter field is depicted in FIG. 4. For example, FIG. 4 shows packet filter list 400 when TFT 300 operation is to delete packet filters from the existing TFT 300.

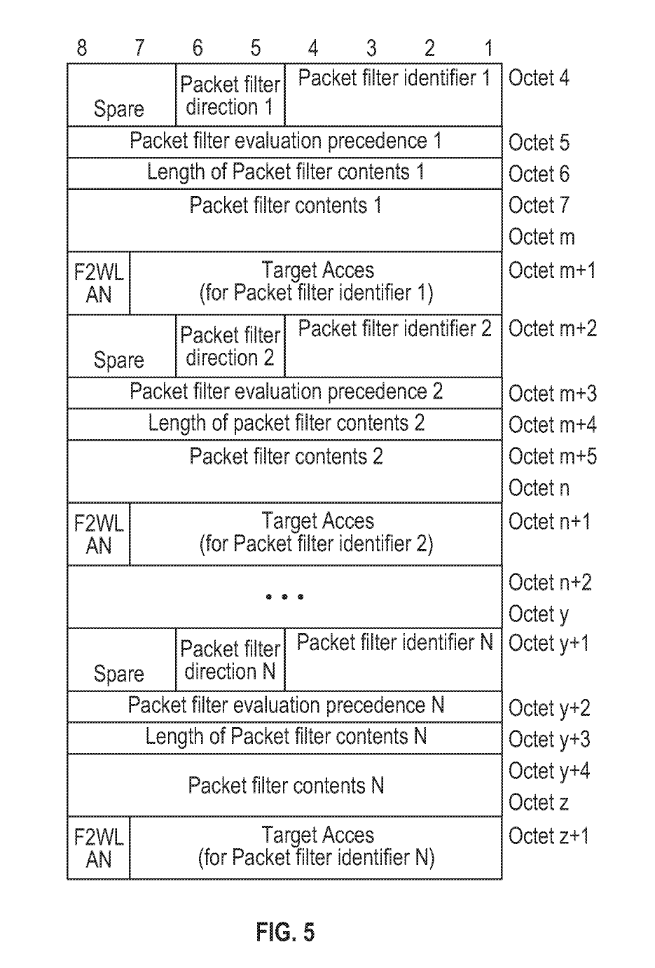

FIG. 5 shows packet filter list 500 when TFT 300 operation is to create new TFT 300 or add packet filters to TFT 300 or replace packet filters in TFT 300. As shown in FIG. 5, a target access for a data flow may be defined using two bits. For example, the target access for the 3GPP access network (E-UTRAN 104/UTRAN 116/GERAN 118) may be defined by bits 00 and the target access for WLAN 106 access by bits 01. The other combination of the target access field bits may be reserved for other communication networks.

In addition, a fallback field may also be added to the target access field. The fallback field is represented by F2WLAN field in FIG. 5. The fallback field may be used to define binding characteristics of the target access. The fallback field may comprise a single bit field. For example, bit 0 in the fallback field may represent that fallback is not allowed for the data flow, and bit 1 in the fallback field may represent that fallback is allowed for the data flow.

The fallback field may provide an indication of a nature of the binding between the 3GPP access and corresponding packet filter. For example, the fallback field may be ignored when the target access is set to other than the 3GPP access network. “Not allowed” in the fallback field may indicate that the data packet matching the corresponding packet filter cannot be routed via any access other than the target access. In an event of unavailability of the 3GPP access network, corresponding data packets may be dropped locally at UE 102 and PDN gateway 120. “Allowed” in the fallback field may indicate that, in an event of unavailability of the target access, the data packet may be routed through another available access. For example, if the 3GPP access network is not available, the data packets may be routed through the available WLAN 106 based on the specified packet filter. Hence, UE 102 and PDN gateway 120 may automatically select the other available access to route the packet in the event of unavailability of the 3GPP accesses network.

The enhanced format of the common TFT as described above may be used by both PDN gateway 120 and UE 102 to establish the ARR. The target access field of the packet filter may indicate the access type to which the corresponding packet filter is bound. UE 102 and PDN gateway 120 may continue to support the existing mechanism of matching the data packets with packet filters, based on the packet filter precedence and direction. A precedence value may be unique across access types. When the data packet matches a packet filter, based on the above ARR table, the corresponding target access may be selected to deliver the data packet. PDN gateway 120 may perform this access binding for each downlink data packet and UE 102 may perform the same for each uplink data packet. For example, PDN gateway 120 may include a routing circuit configured to route the downlink data packets.

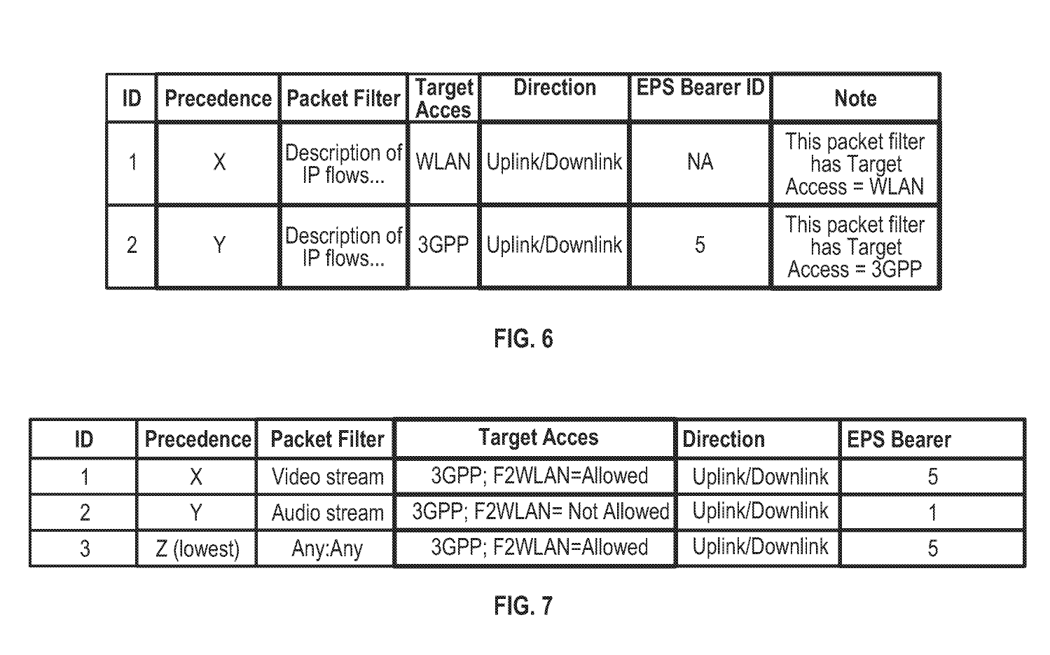

UE 102, which may be attached to PDN gateway 120 via the 3GPP access network and WLAN 106, may be provided with the ARR (using the enhanced TFT) by PDN gateway 120. UE 102 and PDN gateway 120 may generate ARR as shown in FIG. 6. UE 102 may apply packet filter in an uplink direction while PDN gateway 120 may apply the packet filter in a downlink direction. EPS Bearer ID, as shown in FIG. 6, may only be applicable for the 3GPP access networks, and it may allow binding of the packet filter to specific radio access bearer within 3GPP access networks (e.g. E-UTRAN 104/UTRAN 116/GERAN 118).

In addition to the target accesses, the ARR may further include charging rules for the data flow mobility. For example, policy and charging rules function (PCRF) 122 may be locally configured with a policy and charging control (PCC) rule corresponding to the target access binding. For each PCC rule, the access binding may be strict or preferred. Below is the example of PCC rule configuration at PCRF 122.

PCC Rule1: {packet-filter=video stream,

ID=1,
{Target-Access=WLAN, Charging-Key=1},
{Target-Access=3GPP, Fallback-to-WLAN=Allowed, Charging-

Key=2}

}

PCC Rule2: {packet-filter=audio stream,

ID=2,
{Target-Access=3GPP, Fallback-to-WLAN=Not Allowed,

Charging-Key=3}

}

PCC Rule3: {packet-filter=any,

ID=3,
{Target-Access=WLAN, Charging-Key=4},
{Target-Access=3GPP, Fallback-to-WLAN=Not Allowed,

Charging-Key=5}

}

PCRF 122 may be configured with different charging-keys based on the target access type when the 3GPP access network and WLAN 106 are allowed for the given data flow. For example, there may be different charging rates, hence multiple charging keys, based on whether WLAN 106 access is allowed or not allowed for the given data flow (configured as a part of the fallback field). PCRF 122 may be configured to provide charging information when the corresponding data flow is installed in a policy and charging enforcement function (PCEF). At this point, UE 102 may not have been connected via the 3GPP and WLAN 106 accesses.

Before initialization of the data mobility, PDN gateway 120 may be configured to map the target access of the PCC rule to the target access field of the TFT packet filter while providing the packet filters to UE 102. Additionally, if fallback field is set to allowed, PDN gateway 120 may modify the TFT and set the fallback field of the corresponding TFT packet filters. The modified TFT may be provided to UE 102 during data flow installation—i.e. during bearer modification or bearer establishment procedure. UE 102 may not have been connected to WLAN 106 access at this point of time. Accordingly, the ARR table at PDN gateway 120 and UE 102 may be as depicted in FIG. 7. As shown in FIG. 7, all data flows before initiation of the flow mobility may be bound to the 3GPP access. UE 102 may be configured to apply the packet filter in the uplink direction and PDN gateway 120 may be configured to apply the packet filter in the downlink direction. The EPS bearer ID may only be applicable to 3GPP access network, and may allow binding of the packet filter to a specific radio access bearer within the 3GPP access network.

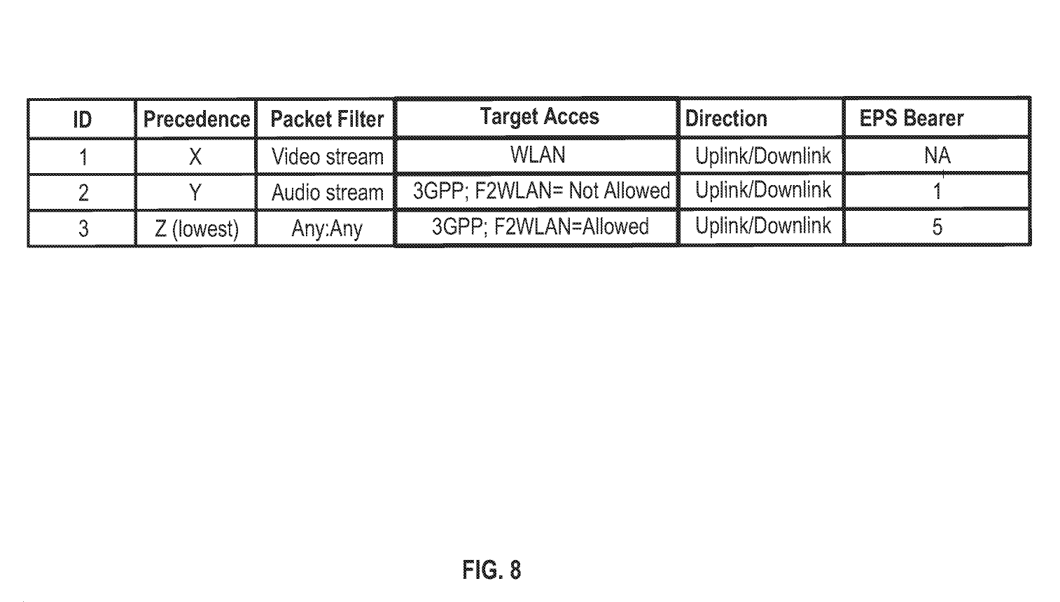

When UE 102 gains access to WLAN 106, UE 102 may automatically switch the data flow based on the ARR of FIG. 7. For example, UE 102 may switch the data flow for which fallback is set to “allowed”, and may route via WLAN 106, for the uplink packets. PDN gateway 120 may perform reflective access binding of the data flow. For example, based on the access selected by UE 102 for the uplink data packet, PDN gateway 120 may select the same access to route the downlink packet of the corresponding data flow. A modified ARR is shown in FIG. 8 after UE 120 have attached via WLAN 106 and starts routing some of the data packets via WLAN 106.

In some embodiments, due to mobility or other reasons, UE 102 may move out of the coverage of one of the accesses. For example, UE 102 may move out of the coverage range of WLAN 106. When UE 102 moves out of the coverage range of WLAN 106, WLAN 106 access may be removed from the target access list (ARR) for UE 102 and PDN gateway 120. When the WLAN 106 access is removed from the PDN connection, the access binding rules, bound to WLAN 106, may be configured to be automatically bound to a default access network. For example, the access binding rules may be modified to include the 3GPP access network as the default access. Hence, UE 102 and PDN gateway 120 may start routing all the data flows via the 3GPP access network. In addition, PDN gateway 120 may initiate activation/modification of the bearer procedure. For example, PDN gateway 120 may initiate the modification of the ARR table, such as the last ARR table of FIG. 8.

The 3GPP access network nodes may follow the procedure defined in the 3GPP TS 23.401 to remove the PDN connection and hence perform the removal of the 3GPP access from the PDN connection. When the 3GPP access network is removed from the PDN connection, the access binding rules, bound to the 3GPP access networks, may be handled based on the fallback setting. Hence, based on the ARR table of FIG. 8, fallback to WLAN 106 may be allowed for the access binding rules with ID=3. Thus, UE 102 and PDN gateway 120 may route the IP packets belonging to access binding rule ID=3 via WLAN 106.

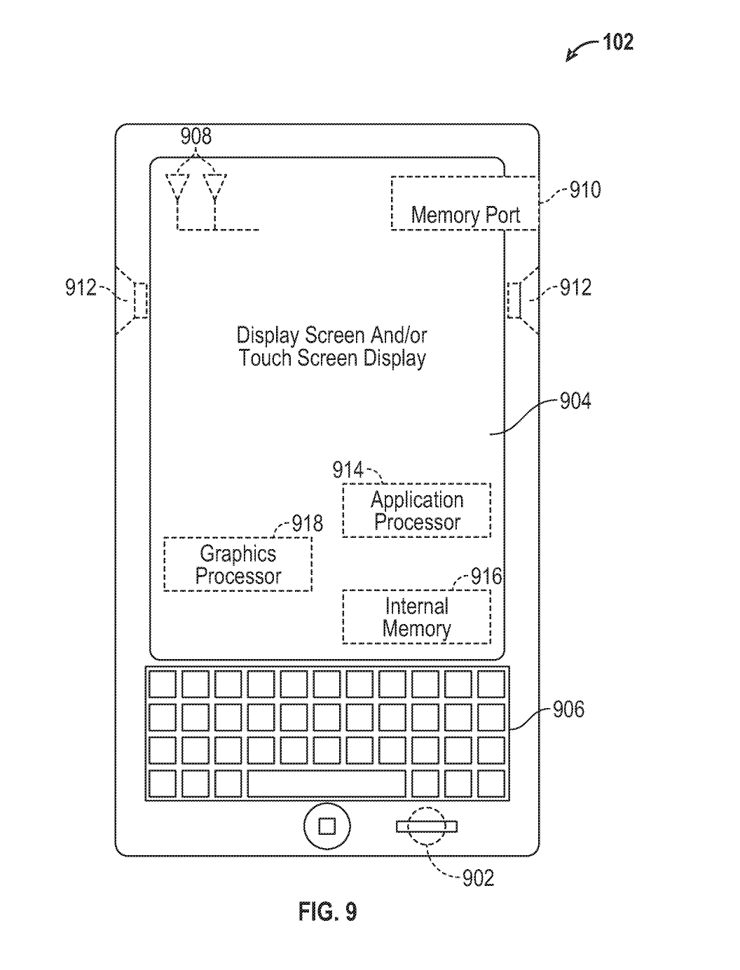

FIG. 9 shows a block diagram of user equipment 114. UE 102 may be a mobile wireless device, a mobile communication device, a tablet, a handset, or other type of mobile wireless device. As shown in FIG. 9, UE 102 may be include a data input port 902, a display screen 904, a keyboard 906, antennas 908, a memory port 910, speakers 912, an application processor 914, an internal memory 916, and a graphics processor 9118.

Data input port 902 may include a microphone and an imaging device, such as a video camera. Data input port 902 may be configured to capture data provided by a user. For example, the microphone may be configured to capture audio data and the imaging device may be configured to capture video data. The data captured by microphone and the video capturing devices may be provided as data packets.

Display screen 904 may be configured to display data received by UE 102 to the user. Display screen 904 may be a liquid crystal display (LCD) screen, or other type of display screen such as an organic light emitting diode (OLED) display. Display screen 904 may be configured as a touch screen. The touch screen may use capacitive, resistive, or another type of touch screen technology.

Keyboard 906 may be configured for the user to input information to UE 102. Keyboard 906 may be integrated with UE 114 or connected to UE 102 externally, such as wireless keyboard. Keyboard 906 may be a virtual keyboard and may be provided using the touch screen.

Antennas 908 may be configured to communicate with the core network such as (E-UTRAN 104) or other type of WWAN access point, such as WLAN 106, or other network equipment (NE). For example, antennas 908 may enable EU 102 to communicate using at least one wireless communication standard including the 3GPP LTE, WiMAX, High Speed Packet Access (HSPA), Bluetooth, and Wi-Fi. Separate antennas may be used to communicate with each wireless communication standard or shared antennas for multiple wireless communication standards may be used.

Memory port 910 may be configured to provide interface to external memory, such as a non-volatile memory. Hence, memory port 910 may also be used to expand the memory capabilities of UE 102. Speakers 912 may be used for providing audio output from UE 102. Application processor 914 and a graphics processor 918 may be coupled to internal memory 916 to provide processing and display capabilities.

One example advantage of the methods and systems described above may include providing the ARR bound to WLAN 106 via the 3GPP NAS, thereby making it transparent to the WLAN nodes, i.e. ePDG 126. No new functionality may be needed to enable the core network based data flow mobility. PDN gateway 120 and UE 102 may simply use a common table prepared from the TFT to perform access binding for the data flow and within the selected access, access specific bearer binding—e.g. radio bearer binding applicable to the 3GPP access for the data flow. Another advantage may include providing a common operation for manipulation of the packet filter (i.e. add/replace/delete operation) across accesses via the ARR. In addition, a common precedence of the packet filter across accesses may be achieved. Since the TFT is transparent, no changes may be needed at MME 108, SGSN 110, or serving gateway 114. The existing MME 108/SGSN 110/serving gateway 114 along with upgraded UE 102 and PDN gateway 120 may be used. This may ease roaming consideration since vPLMN nodes may not be impacted.

Although several of the described example embodiments were included with reference to the use of the 3GPP standard wireless network implementations, it will be understood that the present techniques may be implemented in connection with a variety of other wireless wide area network standards, such as WiMAX, CDMA2000, EV-DO, and other 2G, 3G, 4G, and 5G-standard WW AN protocols and devices. Likewise, although several of the described example embodiments were included with reference to the use of Wi-Fi and WLAN communication standards from the IEEE 802.11 standards family, the present techniques may be implemented in connection with a variety of other wireless local area network standards and protocols. Therefore, the terms “WWAN,” “WLAN,” and “wireless network” as used herein are not necessarily intended to be limiting to the use of any particular radio access, but may also include a variety of wireless radio access and devices communicating via such wireless radio access.

Embodiments of the disclosure, for example, may be implemented as a computer process (method), a computing system, or as an article of manufacture, such as a non-transitory computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed is:

1. A method comprising:
receiving an access routing rule;
receiving a first data packet;
determining a first packet filter associated with the first data packet;
determining a first target access corresponding to the first packet filter based on the access routing rule; and
routing the first data packet through the first target access.

2. The method of claim 1, wherein receiving the access routing rule comprises receiving the access routing rule through a 3rd Generation Partnership Project (3GPP) access network.

3. The method of claim 2, wherein receiving the access routing rule through the 3GPP access network comprises receiving the access routing rule through a 3GPP access network access stratus (NAS) interface.

4. The method of claim 1, wherein determining the first target access comprises determining the first target access wherein the first target access is associated with one of a plurality of communication networks.

5. The method of claim 4, wherein routing the first data packet further comprises:
determining the one of the plurality of communication networks associated with the first target access; and
routing the first data packet through the one of the plural of communication networks.

6. The method of claim 5, wherein routing the first data packet through the one of the plurality of communication networks comprises routing the data first packet through the one of the plurality of communication networks wherein the plurality of communication networks are: a wireless local area network and a 3rd Generation Partnership Project (3GPP) access network.

7. An apparatus comprising:
a user equipment comprising a processor configured to:
receive an access routing rule through a first communication network;
receive a first data packet;
determine a first packet filter associated with the first data packet;
determine a first target access corresponding to the first packet filter by performing a lookup operation in the access routing rule; and
routing the data packet through the first target access.

8. The apparatus of claim 7, wherein the first communication network is a 3rd Generation Partnership Project (3GPP) access network.

9. The apparatus of claim 8, wherein the access routing rule is received in a traffic flow template (TFT).

10. The apparatus of claim 9, wherein the TFT comprises a mapping of a plurality of packet filters and a target access field corresponding to each of the plurality of packet filters.

11. The apparatus of claim 10, wherein the target access field comprises the first target access corresponding to the first packet filter.

12. The apparatus of claim 10, wherein the target access field further comprises a fallback field, the fall back field indicating a nature of binding between the first target access and the first data packet.

13. The apparatus of claim 12, wherein when a value of the fallback field is set to not allowed, the first data packet is not allowed to be routed through a second target access other than the first target access.

14. The apparatus of claim 12, wherein when a value of the fallback field is set to allowed, the first data packet is allowed to be routed through a second target access indicated in the target access field.

15. The apparatus of claim 7, wherein the access routing rule further comprises a charging key for routing the first data packet through the first target access.

16. The apparatus of claim 7, wherein when access to the first target access is not available, the processor is further configured to drop the first data packet.

17. A system comprising:
a network node comprising a routing circuit, the routing circuit configured to:
send an access routing rule to an user equipment;
receive a first data packet;
determine a first packet filter associated with the first data packet;
determine a first target access corresponding to the first packet filter, wherein the first target access is determined based on the access routing rule; and
route the data packet to an user equipment through the first target access.

18. The apparatus of claim 17, wherein the access routing rules is sent in a traffic flow template, and wherein the first target access is stored in a target access field of the traffic flow template.

19. The apparatus of claim 18, wherein the target access field further comprises a charging key, the charging key indicating a charging rate for routing the first data packet through the first target access.

20. The apparatus of claim 18, wherein the first target access is associated with a first communication network, and wherein the first communication network is a 3rd Generation Partnership Project (3GPP) access network.
